(19) United States
(12) Patent Application Publication
(10) Pub. No.: US 2007/0027840 A1
(43) Pub. Date: Feb. 1, 2007

(54) Searching method and system

(75) Inventors: Robbie Cowling, Mapstones (GB); James Anthony Wren, Rayleigh (GB)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Jobserve Limited

(21) Appl. No.: 11/189,788

(22) Filed: Jul. 27, 2005

(51) Int. Cl. G06F 17/30

(52) U.S. Cl. 707/3

(57) ABSTRACT

The present invention relates to searching a data store comprising data about users who are attempting to identify other users associated with the data store. Examples include the recruitment field in which employers are seeking employees, and vice versa; and the dating field in which user A is seeking users B having certain characteristics, and vice versa. The present invention provides a database management method for managing the interactions between a database and users of the database, the database comprising user data associated with respective users, the method comprising: entering user entered data into the database; monitoring user interactions with the database and entering into the database user interaction data corresponding to the monitored user interactions of respective users of the database; receiving a query from a searching user to identify a target user according to search criteria entered by the searching user; processing the query by searching the user entered data and/or the user interaction data in order to identify a number of target users having user entered data and/or user interaction data matching the criteria; ranking the identified target users depending on the user entered data and/or the user interaction data of the respective identified target users; wherein the user interaction data is used by at least one of the query processing or ranking steps.

### FIELD OF THE INVENTION

The present invention relates to searching a data store comprising data about users who are attempting to identify other users associated with the data store. Examples include the recruitment field in which employers are seeking employees, and vice versa; and the dating field in which user A is seeking users B having certain characteristics, and vice versa.

### BACKGROUND OF THE INVENTION

In the recruitment field, there are three main methods of identifying suitable candidate employees: by placing advertisements; by head hunting; and by performing a database search using an Agency or similar intermediary. Placing advertisements is time consuming, especially as many unsuitable candidates may apply and therefore it is necessary to filter these out in order to identify a list of suitable candidates. Head hunting is expensive as it is normally required to pay a significant percentage of the successful candidate's salary or hourly rate. A database search, such as those provided by a web based agency, are convenient, identify only qualified candidates and are cost-effective. However the matching results may include qualified candidates who are no longer looking or for other reasons are no longer suitable, and therefore highlighting currently suitable candidates can still be time consuming.

FIG. 1 illustrates a known data store architecture and comprises a database storing information about a number of users and which is shown here logically split into type A and type B databases for ease of explanation. Type A users, for example employers, enter details about jobs available, the qualities such as qualifications they are looking for in an employee, the location and possibly an indication of remuneration. This information is stored in the type A database, which can be searched by type B users, for example employees. The type B users enter search criteria into a search engine coupled to the type A database, which identifies all the type A users matching these criteria. Similarly, type B users such as employees enter details about themselves into the type B database, including their qualifications, experience, location, CV information and so on. This data can then be searched by the type A users (employers) to identify suitable candidates for a current job opening. However, as noted above, such search results can still require further filtering in order to highlight a list of suitable type B users.

Similar problems exist in other fields in which alterative parties seek each other out via an intermediary. For example in the dating field, a man (type A) may be seeking a woman (type B) having certain characteristics, however the matching list of results may include women who are no longer looking for a man.

### SUMMARY OF THE INVENTION

In general terms in one aspect the present invention provides a searching system in which users who are searching for other “target” users of the system, can enter their search criteria and locate, identify or highlight the most suitable target users based not only on the information provided directly by the target user but also using information about their searching habits or database interactions. The searching habits of users of the system are extracted from user interactions with a data store which stores information about the users. The users of the system will enter data (user entered data) about themselves and/or their requirements of other users they are trying to identify. The further data relating to the user's searching of the data store (user interaction data) adds to the user entered data about each respective user which the user has entered themselves, and may be used for example to highlight employees who are still actively using the system to search for jobs, compared with employees who haven't used the system for several months and might therefore be considered to be not looking for work at the moment. The user interaction data might also provide additional information about what the respective user is looking for and which they didn't enter (the entered data) themselves. For example a man who entered that he is looking for a date with a woman who likes children, may in fact be actively searching for or only look at search results which are for blonde woman. Therefore the system may highlight blonde woman in a results list for women who say they like children.

The system therefore provides a more efficient search, as the most relevant search results (eg suitable candidates who are still looking, or blonde women) are given the best rankings and are therefore highlighted to the searching user. The system does this by introducing new sources of data into the searchable database which had not previously been considered; that is data relating to the target users own searching activity. In an embodiment this is achieved by ranking the search results achieved with the user entered data, according to the user interaction data of the list of target users. Examples of this user interaction data include dates of searches carried out by the type B users, which type A users they looked at when carrying out their own searches, and which type A users they applied to. This “flip-side” information may then be utilised when the searching user is a type A user and the target user is a type B user.

In alternative embodiments, the user interaction data might be used to process a query corresponding to search criteria entered by a searching user; the ranking of the identified target users being based on the user entered data and/or the user interaction data. Thus depending on system configuration, the user interaction data might be used only in the identification of target users matching the search criteria, or only in the ranking of target users identified using only the user entered data; or in both the identification and ranking processes.

In one aspect the present invention provides a method of identifying target users in a group of users in which the users search the group to identify other users; the method comprising: determining search criteria; matching the search criteria with information related to the searching habits of potential target users in order to highlight a number of target users.

There is also provided a database management method according to claim 1.

There is also provided a method of collecting data for a database comprising user data associated with respective users of the database and according to claim 13.

There is also provided a method of searching a database comprising user data associated with respective users of the database, the user data comprising both user entered data and user interaction data corresponding to the monitored user interactions of respective users of the database; the method according to claim 14.

There is also provided a database management method for managing the interactions between a database and users of the database, the database comprising user data associated with respective users, and according to claim 15.

There are also provided corresponding apparatus and/or systems for carrying out the above defined methods. There are also provided computer programs having instructions which when implemented are arranged to carry out the above defined methods.

### BRIEF DESCRIPTION OF THE DRAWINGS

Embodiments of the invention will now be described with reference to the following drawings, by way of example only and without intending to be limiting, in which:

FIG. 1 shows a known data store searching system architecture;

FIG. 2 shows a data store searching system architecture according to an embodiment;

FIG. 3 illustrates a method of data extraction and searching for users of the system of FIG. 2;

FIG. 4 illustrates a data store architecture according to an embodiment;

FIG. 5 illustrates a data store architecture having a number of sub-groups;

FIG. 6 illustrates a method of indexing new data items;

FIG. 7 illustrates a method of updating the indexes;

FIG. 8 illustrates how data may be collected in the recruitment field;

FIG. 9 illustrates an asynchronous method of data collection; and

FIG. 10 illustrates a search web page.

### DETAILED DESCRIPTION

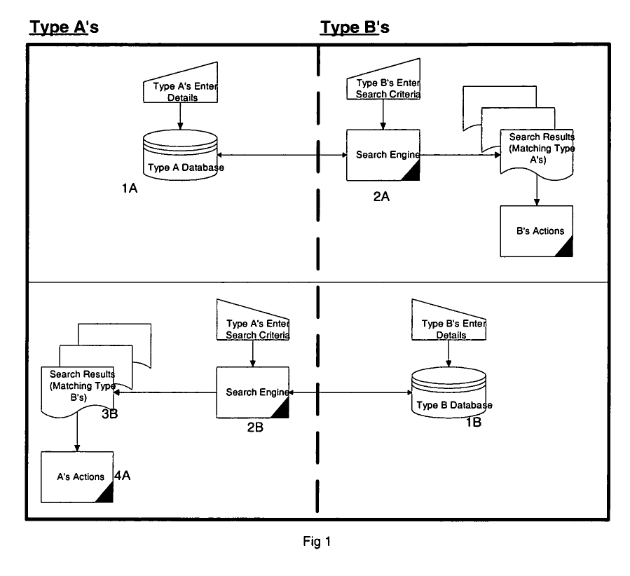

Referring again briefly to FIG. 1, this comprises two databases 1A storing information about type A users of the system (for example employers) and 1B storing information about type B users of the system (for example candidate employees or job seekers). Each database 1A and 1B has a corresponding search engine 2A and 2B which allow searching of their respective database 1A or 1B by other users of the system. The designation type A and type B users are to indicate most generally that one is searching for the other, and vice versa. In an embodiment they may be employer and job seeker respectively, however in another embodiment they could be man and women, or even man and (different) man. Therefore it is not necessarily the case that type A and type B users will have different characteristics, it is just a convenient way in which to distinguish the roles of searchers and targets within the system.

Each user will enter their details into the database 1A or 1B, and another user may query the database for users matching a criteria or search term. In the case of recruitment, this arrangement is separated into type A (eg employer) and type B (job seeker) users. Thus a job seeker (type B) may enter their job requirements, their qualifications and experience, and other information such as desired location and preferred remuneration level. This information or data about the job seeker is stored in the database 1B together with an identifier for the job seeker (B). Employers (type A) may then search for suitable candidate job seekers (B) using the search engine 2B associated with the type B database 1B. Search criteria may include for example qualifications and location. The search engine then returns a list 3B of all type B users matching those search criteria. The searching user (A) then reviews the list 3B of potential suitable candidates, and may further filter these for example based on factors not entered into the search criteria, for example salary expectations. The employer (or their agent) may then approach the remaining candidates to determine whether they are interested in their job. These last steps can be very time consuming, and are represented in the diagram by the searching user actions 4A.

A similar process is applied on the “flip-side” of the system, in which candidates (B) search for suitable jobs offered by employers (A).

The applicants have realised that additional information relating to searches 2A and 2B, and the actions 4A and 4B of searching users A or B can also be used to enhance the search results of other searching users. For example an employer could utilise information about whether otherwise suitable candidates have been searching recently for jobs, to estimate whether those candidates are likely to still be looking for work, and to rank them accordingly in the search results. This may mean for example that the employer only approaches suitable candidates who appear to still be looking for work, and therefore reduces the amount of wasted time in pursuing potential candidates who are less likely to be interested in the job.

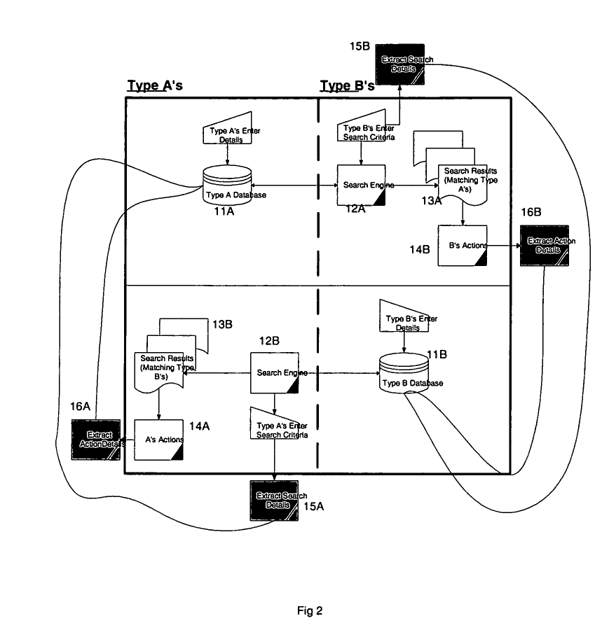

FIG. 2 shows a searching system architecture for implementing this enhanced searching strategy. The type A and type B databases 11A and 11B contain additional user interaction data which relates to the respective users search activities or interactions with the database. For example, when a type A user queries the type B database 11B using the associated search engine 12B, the searching criteria (15A) entered by the type A user are added to the type A database 11A and associated with that searching user A.

Similarly, when A considers the search results list 13B, A's actions 14A in terms of which search results are viewed in more detail and so on are also added to the type A database as further user interaction data (16A) and associated with A. A similar process is carried out with respect to type B searches, and which results in additional information (15B and 16B) about the searching habits or database interactions of the type B searching user.

This additional user interaction data about the type A and type B users in the respective databases 11A and 11B can then be used by the respective search engines 12A and 12B to enhance subsequent searches involving those previous searching users A and B. When a new search is carried out by the search engine 12B searching the type B database 11B, it processes a query as before using search criteria entered by the searching user A. This is the user entered data used in the enhanced search, and results in a list of type B users matching this user entered data or search criteria. The search engine 11B is however further configured to rank or otherwise highlight these results based on whether the user interaction data or searching habits of the type B users on the results list match further ranking criteria.

These ranking criteria may simply be the first searching criteria but applied to additional information contained about the target or type B user in their respective user interaction data. For example if the employer is looking for an engineer for a control engineering job, the search engine 12B may highlight those candidates who have viewed or applied for control engineering jobs, as opposed to engineers who met the first criteria in terms of what is written in their user entered data about themselves (eg in their CV), but who have been searching for other types of engineering jobs. This might indicate for example that the candidate is looking for a career change and would therefore not be as suitable as a similarly qualified candidate who is actively looking for a control engineering job. The further ranking criteria might also be different to those entered by the searching user (in this case A), for example they may have been added by the system to enhance the search results, such as highlighting those candidates who have recently performed job searches over those that haven't.

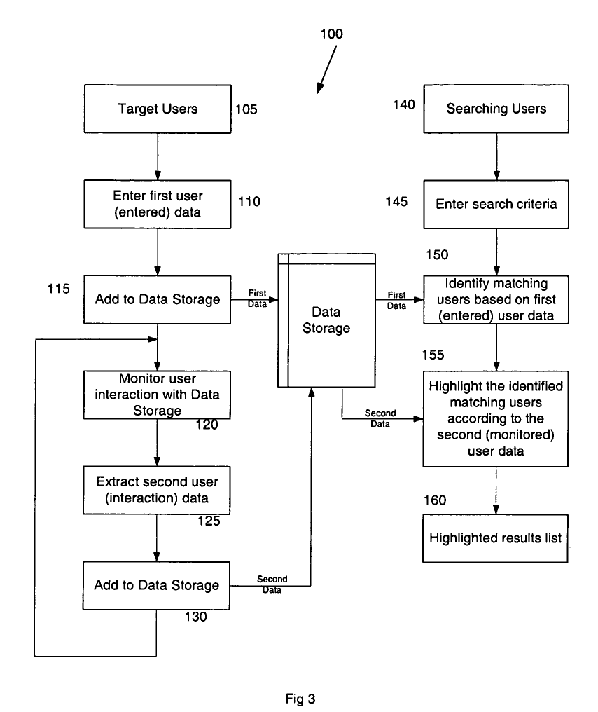

A method further illustrating the data entry and searching aspects of the search system is shown in FIG. 3. Target users (105) enter first or user entered data (110) about themselves into the system. In this example target users are those on which searches will be performed and who may appear on a results list. In practice all users of the system will be target users depending on which user is performing searches. This user entered or first data is added (115) to the data-store. The system then monitors the target users interactions with the system (120) including their use of search terms for carrying out their own searches, and their actions in respect of the results received. For example what characteristics do they appear to be looking for in users appearing on their search results lists. Both of these sets of additional or user interaction data about the target are extracted (125) from their behaviour or interactions with the database, and are added to the database or data-store (130). The system then continues to monitor their subsequent activities.

This addresses a typical problem in databases of this sort, in that users often only enter a restricted amount of data about themselves, or may even enter misleading data. Thus the gathering of the additional data which relates to their actual searching habits can be more accurate about them than the data they enter themselves, and so improves the accuracy of the searches or matching of searching and target users.

A searching user (140), which could be the target user which just entered their user entered data, enters search terms or other criteria into the system (145). The system then identifies all other users of the system matching those search terms (150). This is achieved in this embodiment by identifying users having associated user entered data matching the search criteria. This results in a list of target users. The system then retrieves the additional or user interaction data about the target users on the list in order to highlight these users on the result list (155). For example the highlighting could be by way of a ranking system which orders the search results according to the user interaction data about each target user on the list. In the recruitment example above, this might mean that all job seekers (the target users in this case) on the results list and which have searched the system for jobs within the last week are placed on top of the list. A detailed example of sorting of the list is described further below. In another example the list may simply be filtered to reduce the number of results based on the second data.

Thus the highlighted search results list (160) provides enhanced search results which reduce effort on the part of the searchers in identifying suitable candidates, or in ranking them, and also enhances the efficiency of the searching as more data is considered which means the searching can be more accurately targeted.

In an alternative embodiment, the search criteria may also be matched against user interaction data in order to provide a more comprehensive results list. The ranking criteria will then be slightly different, for example the search criteria may include the requirement that candidates have searched the database within the last two weeks, and the ranking criteria may rank the resulting candidates according to the date they last searched the database. In a further alternative, the initial searching may be based on the user interaction data only, and the ranking based on one or both of the user entered data and/or the user interaction data.

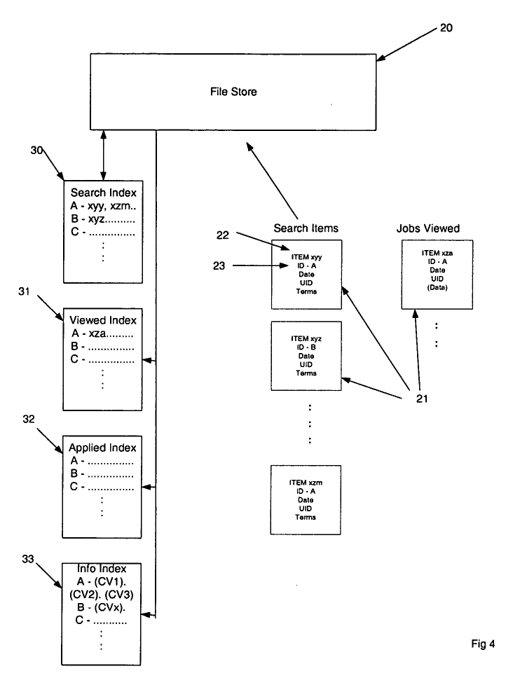

FIGS. 4 to 10 illustrate an embodiment adapted for application to the recruitment field, however the skilled person will appreciate that other embodiments may also be suitable for this application, and indeed that the described embodiment might be suitable for other applications such as dating, with or without modification.

The system comprises a data store that contains information relating to the various users of the recruitment search system such as employers and job seekers. This information will include details such as each users name, address, job type, qualifications, experience, and so on, and constitutes the user entered data which the user enters into the system about themselves. Not all of this data may be available to other users, for example specific names and street addresses of job seekers may not be available to employers to ensure they go through the operator of the system in order to contact the job seeker about their particular job offer. The initial matching of users carried out by the system to a searching users search criteria utilises this data to identify potentially suitable candidates. This aspect of the searching system is well known to those skilled in the art and is not further discussed here.

The system then ranks the resulting list of matching users according to user interaction data stored about the users on the results list. The user interaction data relates to the interactions of the users with the search system, and for ease of explanation is shown here stored in a different logical part of the data store. In this embodiment, the user interaction data is divided into four categories: searches; jobs viewed; jobs applied for; information applied with. The information can be conveniently stored as XML data files in a file store, and the following are examples of each data category.

Searches XML File

- <Items>
- <Item DateTime=“29/06/2005 12:17:07” ID=“769224”

UID=“000676000000007b67a1” PSS=“excelandvbaandlondonc”>

<Data >excel and vba and london |C</Data>

</Item>

- <Item DateTime=“27/06/2005 15:42:43” ID“”

UID=“00067600000000785d5b”
PSS=“excelandlondonandvbanotcc” >
<Data>excel and london and vba not c |C</Data>
</Item>
</Items>

Information Applied with XML File

- <Items>
- <Item DateTime=“20/06/2005 11:04:17” ID=“0000346137”

UID=“0006760000000059d34d”>

<Activated>0 </Activated>
<Markets>01|02|03|04|06|07|08|09|10|11|
12|13|14|15|16</Markets>
<TopTenSkills />
<JobHistory>soleEmployer Oracle 34₁₃ 4 main

PERSONAL CONTENT REMOVED
Sales and Marketing Forms Development. Managed Internal

Development using Forms 3.0. </JobHistory>

<EducationHistory>Cambridge University

PERSONAL CONTENT REMOVED
(some exams completed).</EducationHistory>

<FullCV> Employment History Oracle Oracle Position: Discoverer 9I

Administration Dates

PERSONAL CONTENT REMOVED
English and Spanish</FullCV>

</Item>
</Items>

Applications XML File

- <Items>
- <Item DateTime=“29/06/2005 13:10:56” ID=“4446536”

UID=“000676000000007b82af”>

<Data />
<Position>Desktop Support Specialist - Windows 2000/XP, MS

Office </Position>

<Skills>Desktop Support Specialist - you will ideally be Degree

educated with technical capabilities in Windows 2000, Windows XP,
MS Office suite and Exchange. Other responsibilities will include
hardware configuration on desktops, laptops and printers, Active
Directory User Admin and Email Admin and project management
skills would be advantageous. Any experience in the management of
a large user base (eg remote dial-in, Wi FI, Broadband and VPN and
Blackberry) would be beneficial.</Skills >

<Location>West London London London
LN ENG England UK Europe </Location>
<JobType>p</JobType>
<Market>01</Market>
<Latitude>51.5122</Latitude>
<Longitude>−0.065</Longitude>
</Item>
</Items>

Jobs XML File

- <Items>
- <Item DateTime=“18/04/2005 17:53:32” ID=“20762297”

UID=“00067600000000188d21”>

<Data>C # .NET Programmer/C # Developer - London Global Consultancy C #

.NET Programmer/C# Developer London. The worlds number 1 Microsoft
consultancy seek exceptional graduate Junior Consultants to join their
.NET practice designing, developing and implementing innovative
Enterprise (FTSE 100/blue chip) scale C# VB.NET, ASP.NET, SQL Server &
Web Services solutions. They offer unparalleled technical consultancy
career opportunities and superb training (120 hrs/yr) MCSD.NET upon
starting. Successful candidates must be passionate about technology,
eager to learn, driven by challenges and highly ambitious. You will have a
minimum of 6 months C# .NET VB.NET project experience, an excellent
academic record and exceptional communication skills. Salary 21k-26k +
pension + extensive benefits. To apply for this role please send a Word
version of your CV (quoting the job reference) to David Cooper at
davidcooper@client-Server.com or call David on 020 8390 8390 for an
informal chat.|London London London LN ENG England UK
Europe|P|01</Data>
</Item>

- <Item DateTime=“24/05/2005 22:27:30” ID=“20991297”

UID=”000676000000004ab55b”>

<Data>Junior C # .NET Developer - Global Consultancy - London My
client one of the leading players in its field has won some of the biggest
Microsoft projects in Europe. They are looking for Developers with at
least a years C# .NET experience to join they're ever expanding
team. Ideally you will have some ASP.NET experience with a Microsoft background
any experience within OO concepts would be an added bonus. You should have
strong communication skills and a sound understanding of development
life cycle - RUP, MSF, Scrum etc. If you want to earn a good package along
with the backing of one of the best Microsoft teams in the business then
contact Gordon Darroch on 0208 658 1188 or email me your cv at
gordon@networkersint.com.|London London London LN
ENG England UK Europe|P|01</Data>
</Item>
</Items>

Other types of information could alternatively be used, and other methods of storing the data could alternatively be used, for example in a database. The user entered data may also be stored as files in a separate file store, or alternatively in a database for example.

FIG. 4 illustrates a file store arrangement for storing data items corresponding to the above XML data files in each of the four categories of the user interaction data—ie that data gathered from the “flip-side”. The file store 20 comprises a number of XML data files 21 which are extracted from users interactions with the system as described below. The data files 21 are grouped into the four categories: searches; jobs viewed; jobs applied for; and information applied with; though not all of these are shown for clarity. Each data item 21 contains data about an interaction event, for example a search by a user. Each item will contain a unique item number 22 (eg xyz), and an identifier 23 for the associated user (ID-A), and other relevant information; for example each search item will contain the date of the relevant search and search terms used. Each item 21 is stored in a respective category area of the file store 20 in the order in which it was received.

A main index is employed for each category of data in order to facilitate searching and identification of relevant data items. In the figure, a search index 30 is shown for the search items, and this indexes all the search items for each user A, B and so on. For example, user A contains index links to search data items xxy and xzm which are also illustrated in the figure. Thus it can be determined whether user A has performed any recent searches. A text based indexing system is used to index the data items. Such indexing systems are well known to those skilled in the database design and indexing arts.

Indexes 31, 32, and 33 are also provided for each of the other three categories. In each of the jobs viewed and jobs applied for indexes 31 and 32, each user ID 23 will be linked to a file containing the item numbers 22 for all of the jobs viewed/applied for as appropriate. For the information applied with index 33, a separate file is provided for each CV downloaded by an applicant with a job applied for. Thus each user will be associated with a number of files in this index, one for each CV or other information applied with.

Note also that a CV could be user entered data if entered by the user, as opposed to CV's captured by the system when a user applies for a job. In this later case, the CV will form part of the user interaction data.

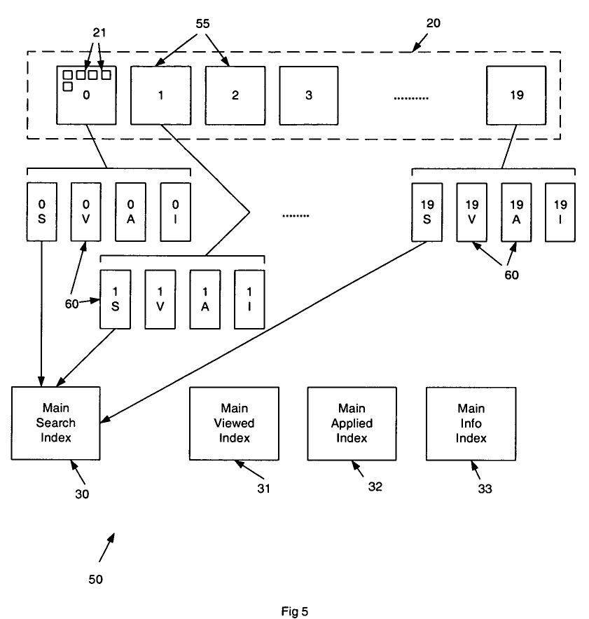

Due to the high volume of data collected in a practical web-based system, and the need for a search index to have the latest data available to be searched, for example all updates within the last five minutes, the file store is split into smaller logical sub-groups. For example the users of the system are split into 20 sub-groups, so that when a user's information is updated, only the smaller logical sub-group of the file store associated with that user requires accessing in order to update the user information. This is illustrated in FIG. 5, which shows a data store 50 having a file store 20 composed of 20 sub-groups 55 each comprising data items 21 typically in the form of XML files associated with a sub-set of users. Each of the sub-groups are also divided into four data types each having a logically separate file store part. The sub-groups are labelled 0-19, and each is associated with four sub-indexes 60. The four sub-indexes of each sub-group 55 of the file store 20 have the same data categories as the main indexes for the user interaction data. However their content is split into smaller groups in order to allow for improved processing and updating. Thus the indexing system is also split into 20 groups, so that each category eg searches or jobs viewed has 20 sub-indexes, each associated only with users in the corresponding group.

The sub-indexes 60 are continuously generated or refreshed with updated data items in the file store. Periodically the sub-index data is combined or merged into a main index 30, 31, 32, 33 which is used for user searching. The use of a separate search index avoids problems associated with trying to search on an index and update it at the same time.

A convenient method for dividing the users up into 20 groups is by using modulo division, in this case MOD20. This allows large quantities of data to be processed faster, by processing the sub-groups in parallel. Each user in the database is assigned a unique 10 digit ID. An example calculation for determining a group for a user is as follows:
User ID 2000011548/20=100000577.4
The remainder is 0.40
So 40/5=8. The user is assigned to group 8.

The process of indexing large quantities of data can take long periods of time, however in an on-line search system it is important to have the new data available as soon as possible. Increased speed can be achieved by indexing the groups independently of each other, giving 20 sub-indexes for each main index (search, jobs viewed, jobs applied, information applied with), and thus a total of 80 indexes for the data store. These indexes are periodically combined together or merged to create a single search index for each interaction data category containing all the searchable information.

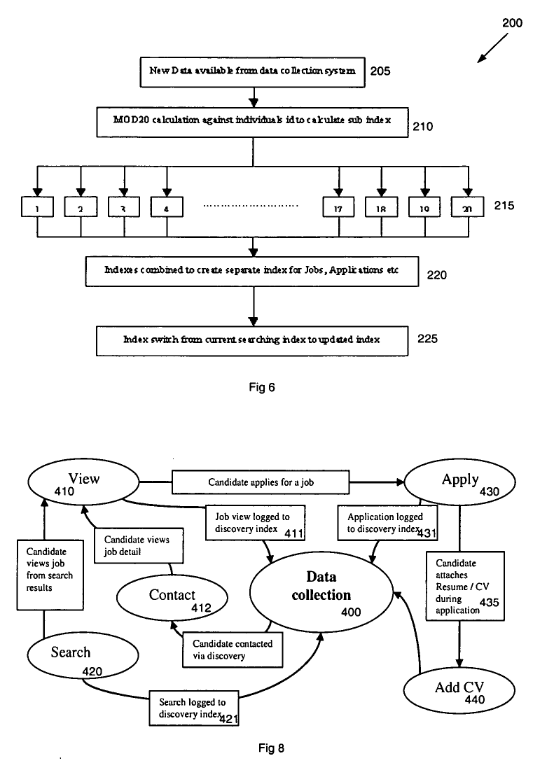

FIG. 6 illustrates a method (200) for updating the indexes when new data is received. When new data or XML data items arrive from a data collection system (205), an MOD20 calculation (210) is performed against the user's ID to determine which sub-index to update. For example if a new search XML file is received, the user ID is obtained and the MOD20 calculation performed. If the group is 8, then the search index for group 8 is updated with the new information in the XML file (215). Periodically the main four indexes are updated by combining or merging their respective 20 sub-indexes (220). Once the main indexes are updated, they are then available for searching again (225).

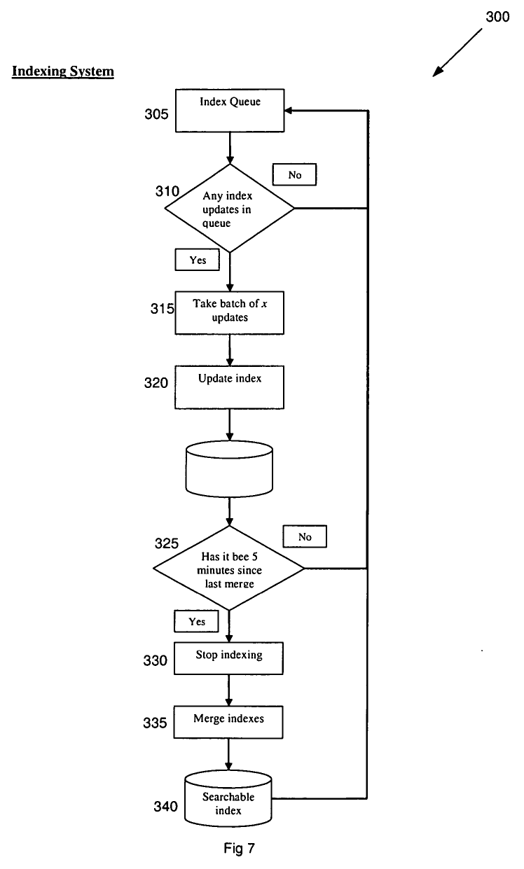

FIG. 7 illustrates a method (300) of updating the indexes of one of the user interaction data categories (eg search). A queuing system is used, and updates to the sub-indexes are added to the queue (305). When the queue contains updates (310), these are taken and the respective sub-index is updated (315, 320). The method (300) then determines whether it has been a predetermined period (5 minutes) since the last merge (325), and if not the method returns to the queue (305). If merging is due, the indexing process for all of the sub-indexes is stopped (330), and the various sub-indexes are merged in order to update the main searchable index for the data category (eg search) (340).

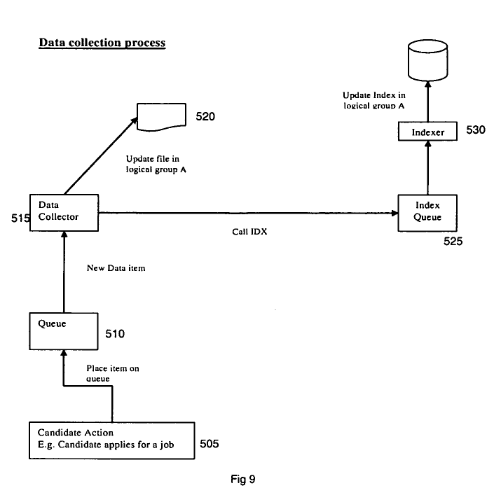

FIGS. 8 and 9 illustrate the data collection process for a job seeking/employer embodiment. FIG. 8 illustrates schematically the data that is gathered to be added to the file store, which will then be indexed as described above. For example when a candidate or job seeker views a job (410), this job view data is logged (411) by the data collection system (400), and stored as an XML file in the file store. The viewing could be the result of the candidate being sent the job details by an employer (contact 412), following a search by the employer for suitable candidates. Alternatively it may have arisen from a search (420) the candidate has carried out. Any searching (420) by the candidate is also logged (421) by the data collection system. If a job seeker or candidate applies for a job (430), this information is also logged (431) by the data collection system (400). Typically this will involve the candidate attaching a CV or similar information to the job application (435). This CV information is also added (440) to the data collection system.

As with updating the indexes, a queuing system is used to update the data collection as illustrated in FIG. 9. For example a candidate action (505) such as applying for a job is added to a data collection queue (510). The data collector (515) therefore receives this “user action” asynchronously, so as not to affect the user, and also to prevent loss if the data collector experiences problems. Therefore the queuing system (510) receives the data items, and releases them to the data collector (515) in a sequential ordered way. The data collector can therefore maintain a steady rate of update of the file store as the queuing system (510) takes the impact during heavy periods of data collection. The queuing system also allows for retrying failed data collections, if the data collector fails to update the file store with a given data item it can retry after a designated time period.

The data collector (515) then adds the new data to the file store (520) as an XML file in the candidate's logical sub-group (A). The data collector (515) also calls the indexing system (525) to index the new data item in the appropriate index, according to the methods of FIGS. 6 and 7. Text based indexing is well known to those skilled in the art and is not further described here.

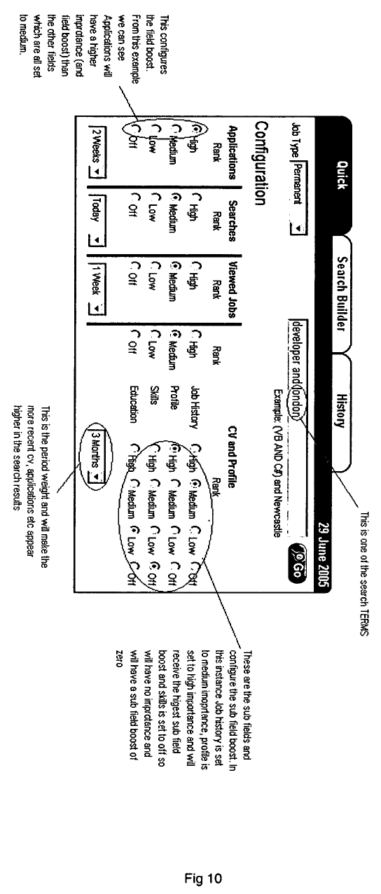

FIG. 10 shows an example search web-page. The search terms are “developer” and “London”, and these correspond to the search criteria which are used to search for developers based in London. This is achieved by matching against the user entered data in the database. The results list obtained is then ranked according to the user interaction data obtained from the flip-side searching, that is the searching habits of those job seekers on the results list. This user interaction data is obtained by searching the four main search indexes previously discussed. As can be seen, the four categories of user interaction data (applications, searches, viewed, and CV/profile) can be weighted, and this corresponds to the ranking criteria in this embodiment. In the example, job applications by the candidate will have a higher importance (or field boost) than the others. The searching of the four types of data indexes can also be filtered on date, for example, the last 2 week, today, and so on. The CV data field, in addition to having a rank of “medium”, also contains sub-fields as follows: job history; profile; skills; education. These sub-fields can also have weightings or sub-field boosts as shown. Each of the data categories also has a period weight (bottom selectable time period in the figure), which will rank matches within this period more highly.

The following algorithms are used to calculate the ranking and order in which the results are returned. A score for each indexed data type is calculated. A data type (eg CV) may be broken down into subsections sections (known as subfields) if a higher importance is to be placed on an individual part of the data type. A subfieldboost is used to change the importance of an individual section or sub-field of a data type, for example work history in the CV data type. This is achieved by multiplying the original score with a number between 0 and 2 which will have the effect of decreasing or increasing the final score. A PeriodWeight is used in the same way as the subfieldboost to give a higher relevancy to the more recently performed actions.

$$FieldScore = \frac{{\sum }_{Matches} ( \begin{matrix}[ {\sum }_{subfields} ( SubFieldBoost * Terms ) ] * \\ PeriodWeight\end{matrix} )}{NumberofMatches}$$

Each of the scores from the individual user interactive data types are then combined to calculate the overall field score.

The FieldBoost is used to change the importance of an individual data type, this is achieved by multiplying the original score with a number between 0 and 2 which will have the effect of decreasing or increasing the final score.

$$OverallFieldScore = \frac{{\sum }_{fields} ( FieldScore * FieldBoost )}{FieldCount}$$

$$MaximumFieldScore = [ {\sum }_{subfields} SubFieldBoost ] * TotalTerms * {PeriodWeight}_{max}$$

$$FieldScore \% = \frac{FieldScore}{MaximumFieldScore} * 100 \%$$

$$MaximumOverallFieldScore = \frac{{\sum }_{fields} ( MaximumFieldScore * FieldBoost )}{FieldCount}$$

The overall field score percentage is used to calculate the final order of the results to be returned by the search.

$$OverallFieldScore \% = \frac{OverallFieldScore}{MaximumOverallFieldScore} * 100 \%$$

In an alternative embodiment the initial search, for example using the search criteria or terms ‘Control Engineer and London’, is performed against the four indexes (Searches, Applications, CVs and Jobs) of the user interaction data simultaneously. These results are combined to generate a list of all candidates returned.

These results are then ranked using the ranking algorithm described above, and also based on the user interaction data. For example:

Search for ‘Control Engineer and London’

The job search returns candidates: A, B, C, D

The Applications search returns candidates: A, B

The CVs search returns candidates: A, E, C, D

The Searches search returns candidates: A, B, E, F

Candidates returned will be: A, B, C, D, E, F

The order they are returned will be dependant on the score from the ranking algorithm. For the candidates that did not appear in the search results for one type of search they will get a score of 0 for that section. Based on the above results, it seems likely that candidate A will appear first on the results list as he/she has appeared on all the four types of index searches.

Whilst embodiments have been described with respect to the recruitment industry, other groups of users could alternatively be used. Examples include people looking for or offering holidays such as flights, or other travel products, and hotel rooms; car, house or other commodity sellers and buyers; and gambling or auction applications.

The skilled person will recognise that the above-described apparatus and methods may be embodied as processor control code, for example on a carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus the code may comprise conventional programme code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware. The skilled person will also appreciate that the various embodiments and specific features described with respect to them could be freely combined with the other embodiments or their specifically described features in general accordance with the above teaching. The skilled person will also recognise that various alterations and modifications can be made to specific examples described without departing from the scope of the appended claims.

1. A database management method for managing the interactions between a database and users of the database, the database comprising user data associated with respective users, the method comprising:
entering user entered data into the database;
monitoring user interactions with the database and entering into the database user interaction data corresponding to the monitored user interactions of respective users of the database;
receiving a query from a searching user to identify a target user according to search criteria entered by the searching user;
processing the query by searching the user entered data and/or the user interaction data in order to identify a number of target users having user entered data and/or user interaction data matching the criteria;
ranking the identified target users depending on the user entered data and/or the user interaction data of the respective identified target users;
wherein the user interaction data is used by at least one of the query processing and ranking steps.

2. A method according to claim 1 wherein the user interaction data is used by both the query processing and ranking steps.

3. A method according to claim 1 wherein the user interaction data associated with a user is determined from the search criteria entered by the user when querying the database and/or by selections made by the user of targets identified by the query.

4. A method according to claim 1 wherein monitoring user interactions comprises capturing predetermined data related to a respective database interaction, and adding this as a file to a file store which forms part of the database.

5. A method according to claim 4 wherein the database further comprises a main index for indexing the users to the files stored in the file store.

6. A method according to claim 5 wherein the adding a file to the file store is accomplished asynchronously by utilising a queue.

7. A method according to claim 6 wherein the file store is divided into smaller logical sub-groups of users, and a corresponding sub-index is provided for each group, and wherein each file store group and each sub-index can be processed independently of each other.

8. A method according to claim 7 wherein the sub-indexes are periodically merged in order to update the main index, updating of the sub-indexes being halted in order to complete the merging operation.

9. A method according to claim 1 wherein the group of users comprises one of the following groups: job seekers and job providers; persons seeking dating partners; holiday providers and holiday seekers; home vendors and home buyers; car sellers and car buyers.

10. A method according to claim 9 wherein the users comprise job seekers and job providers and the monitored user interactions comprise the following four types: dates of searching the database; jobs viewed; jobs applied for; resume data applied with.

11. A method according to claim 10 wherein the database comprises four main indexes corresponding to the four types of monitored user interactions.

12. A method according to claim 10 further comprising the searching user contacting a target user via an administrator of the database.

13. A method of collecting data for a database comprising user data associated with respective users of the database, the method comprising:
entering user entered data into the database;
monitoring user interactions with the database and entering into the database user interaction data corresponding to the monitored user interactions of respective users of the database;
wherein both the user entered data and the user interaction data is made available for searching in order to identify target users by searching users of the database.

14. A method of searching a database comprising user data associated with respective users of the database, the user data comprising both user entered data and user interaction data corresponding to the monitored user interactions of respective users of the database; the method comprising:
receiving a query from a searching user to identify a target user according to search criteria entered by the searching user;
processing the query by searching the user entered data and/or the user interaction data in order to identify a number of target users having user entered data and/or user interaction data matching the criteria;
ranking the identified target users depending on the user entered data and/or the user interaction data of the respective identified target users;
wherein the user interaction data is used by at least one of the query processing and ranking steps.

15. A database management method for managing the interactions between a database and users of the database, the database comprising user data associated with respective users, the system comprising:
monitoring user interactions with the database and entering into the database user interaction data corresponding to the monitored user interactions of respective users of the database;
receiving a query from a searching user to identify a target user according to search criteria entered by the searching user;
processing the query by searching the user interaction data in order to identify a number of target users having user interaction data matching the criteria.

16. A method according to claim 15 further comprising ranking the identified target users depending on the user interaction data of the respective identified target users.

17. A computer program product having computer readable instructions which when executed on a computer carry out the method of claim 1.

18. A database management system for managing the interactions between a database and users of the database, the database comprising user data associated with respective users, the system comprising:
a user data entry interface arranged to receive user entered data and enter said data into the database;
a monitoring processor which captures and processes user interactions with the database to generate user interaction data corresponding to the monitored user interactions of respective users of the database, the monitoring processor further arranged to enter the user interaction data into the database and associate this with respective users;
a user query interface arranged to receive search criteria from a searching user in order to identify a target user;
a query processor which searches the user entered data and/or the user interaction data for target users having user entered data and/or user interaction data matching the search criteria;
a ranking processor which ranks the matching target users depending on the user entered data and/or the user interaction data of the respective identified target users;
wherein the user interaction data is used by at least one of the query processing and ranking steps.

19. A system according to claim 18 wherein the user interaction data associated with a user is determined from the search criteria entered by the user when querying the database and/or by selections made by the user of targets identified by the query.

20. A system according claim 18 wherein the monitoring processor is arranged to capture predetermined data related to a respective database interaction, and add this as a file to a file store which forms part of the database.

21. A system according to claim 18 wherein the group of users comprises one of the following groups: job seekers and job providers; persons seeking dating partners; holiday providers and holiday seekers; home vendors and home buyers; car sellers and car buyers.

22. A system according to claim 21 wherein the users comprise job seekers and job providers and the monitored user interactions comprise the following four types: dates of searching the database; jobs viewed; jobs applied for; resume data applied with.
